(19) United States
(12) Patent Application Publication
(10) Pub. No.: US 2007/0294403 A1
(43) Pub. Date: Dec. 20, 2007

(54) THIRD PARTY DATABASE SECURITY

(76) Inventor: Steven N. Verona, Penn Valley, PA (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/765,623

(22) Filed: Jun. 20, 2007

Related U.S. Application Data
(60) Provisional application No. 60/814,968, filed on Jun. 20, 2006.

(51) Int. Cl. G06F 15/173

(52) U.S. Cl. 709/225

(57) ABSTRACT

A method for increasing the control people and companies have over release of financial and other sensitive information. The method includes the use of a password that expires in a predetermined amount of time or after a predetermined number of uses. The password is given to a creditor or other third party desiring access to such information from information companies, such as credit reporting bureaus. With the password, the creditor can access the person's information. Without the password, or once the password has expired, the creditor cannot access the person's information. This permits legitimate credit-seeking persons to obtain credit, and prevents thieves from obtaining credit in someone else's name.

### CROSS-REFERENCE TO RELATED APPLICATIONS

This application claims the benefit of U.S. Provisional Application No. 60/814,968 filed Jun. 20, 2006.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to methods of reducing the possibility of secure data being stolen, such as occurs with so-called “identity theft”.

2. Description of the Related Art

Identity theft issues are a significant problem. It is common and legal for financial database companies, such as consumer credit reporting firms Equifax, TransUnion and Experian, to gather, store, and offer for sale access to information pertaining to other entities such as companies and individuals. The information is typically financial data, but can include corporate and personal information, such as social security numbers, employer identification numbers, criminal reports, corporate structures, etc.

The data collected by database companies has value, because database companies can charge a fee to financial services companies, such as credit card companies, mortgage companies and others, for access to the databases. Such financial services companies review the data prior to granting credit to consumers and others, and gain access to the data by paying a subscription or other fee.

The people and companies whose information has been collected desire control over who may access or purchase the information collected about them so as to avoid identity theft and other security problems that can occur with such sensitive information being easily accessed. However, normal security measures are not appropriate due to the unique nature of the manner by which the financial services companies gain access to the information. This occurs when an entity applies for financial services, such as a credit card. The financial services company then accesses the entity's financial data through a database company. Although the entity must give the financial services company permission to access the database, there is no practical limit to the financial service company's ability to access the data after the need for permission has passed. Furthermore, employees at such companies can access the data illegally in order to steal the identity of entities.

Therefore, there is a need for a method of preventing unauthorized individuals from falsely granting permission to financial services companies to gain access to the financial and other sensitive information of individuals who have not authorized access.

### BRIEF SUMMARY OF THE INVENTION

The invention relates to a method of restricting access to information that is retained by a company and that relates to a person, including a human or corporate entity. The information is restricted to a third party that is authorized by the person to access the information. The method comprises the person obtaining an authorization device, such as a password, that expires after a predetermined event, such as an amount of time or after a predetermined number of uses. The third party receives the authorization device, such as by the authorization device being conveyed to the third party by the person. The third party conveys the authorization device to the company, and the company permits the third party to access the information about the person until the authorization device has expired, and prohibits the third party from accessing the information once the authorization device has expired. The authorization device expires automatically after the passage of the predetermined time or a predetermined number of uses, which subsequently makes the authorization device useless in gaining access to the information about the person.

The step of obtaining the authorization device comprises, in one embodiment, using a password-generating device to create and display a password. Alternatively, a computer program that can generate passwords can be used, as can a web site, a kiosk or an automated or manual telephone system.

The invention thus gives a third party, such as a creditor, a limited time to use, or a limited number of uses of, a unique password to gain access to the information, after which time or number of uses the password becomes useless. The people or companies, referred to herein generically as “entities”, whose information has been collected can thus exercise control over who may access the information. In order for anyone to access the collected information, a password or other authorization device is necessary. The method includes, in one embodiment, the step of the database company issuing a password generating device, including a physical device, a computer program or a password with a defined expiration, to the entity whose information is held by the database company. This protects the release of the information to only those to whom the entity discloses a password, and for a limited time period or number of uses. Because the password changes or expires automatically, the entity does not risk later unauthorized access to the information by disclosing the password.

### BRIEF DESCRIPTION OF THE SEVERAL VIEWS OF THE DRAWINGS

FIG. 1 is a flow chart illustrating exemplary steps in an embodiment of the present invention. The steps are shown in one order, but the method is not restricted to the order shown.

In describing the preferred embodiment of the invention that is illustrated in the drawing, specific terminology will be resorted to for the sake of clarity. However, it is not intended that the invention be limited to the specific term so selected and it is to be understood that each specific term includes all technical equivalents, which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

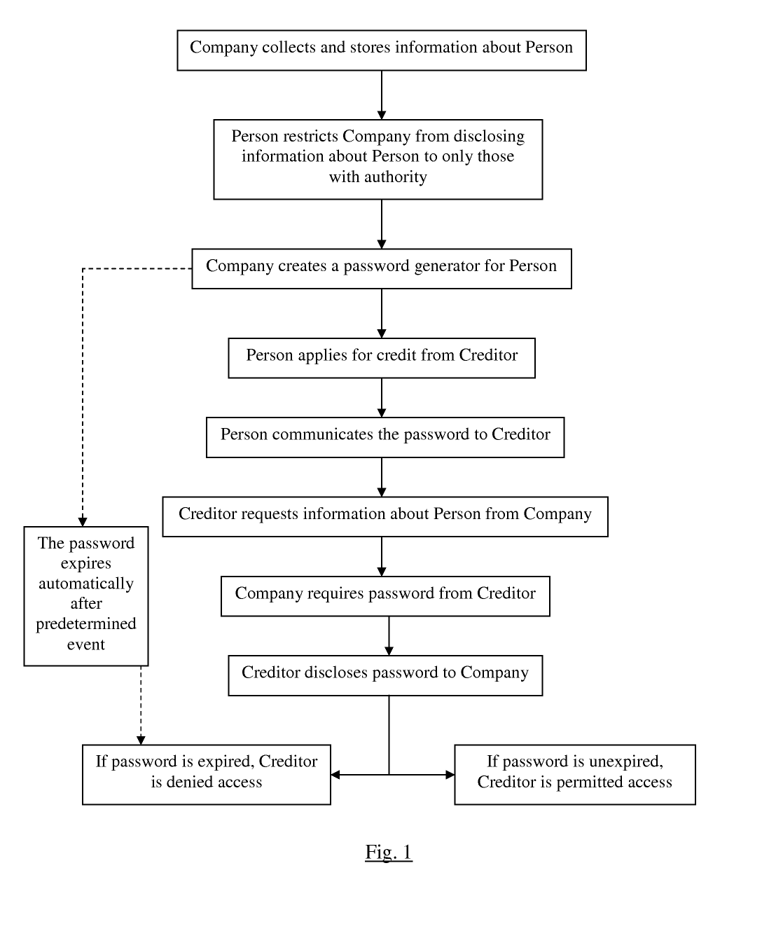

One example of a method that is carried out in accordance with the present invention is illustrated in FIG. 1. The flowchart of FIG. 1 shows a step in which a Company, such as a credit reporting company, collects information about a Person, which includes a human, a corporation, or any other entity about which such information can be gathered. The information typically consists of financial information, but can also include non-financial information, such as corporate structure, litigation history, criminal records, and any other information about a person or entity. This information is gathered in the conventional manner that such information is gathered by such companies, and is stored in a conventional database, such as on a computer hard drive.

Before and/or after the information is collected, the Person to whom the information relates causes the Company to restrict access to such information to authorized entities. This can take place, for example, by the Person entering into a contractual arrangement in which the Company is obligated to restrict access to the information by third parties unless proof of authorization is presented by the third party. It is contemplated that the company will be obligated to require proof of authorization so long as the Person abides by the arrangement, such as by paying a subscription fee or otherwise taking agreed-upon actions. Alternatively, local or national laws may require the Company to maintain the information in confidence without presentation of proof of authorization, such as a password or some other authorization device.

In a typical scenario, the Person next approaches a third party, such as a Creditor if the Person is seeking credit, in the form of, for example, a credit card, loan or other financial instrument. Of course, the method would work with other forms of credit, such as apartment rentals, storage rental, automobile leasing, and any other circumstances in which information about a Person is beneficial to a third party. Before advancing credit, the Creditor must gain access to the information held by the Company, and examine the information to determine whether to advance credit to the Person. However, because the Company is required to keep the information confidential, the Creditor must show proof of authorization before gaining access to the information.

The proof of authorization presented in the preferred embodiment is an authorization device, such as a password made up of a unique series of alphanumeric characters, a digital file or some other unique device used to prove authorization. The preferred embodiment of the invention includes the Company creating a password generator for the Person that generates passwords that expire after a predetermined amount of time from generation, or after a predetermined number of uses. Thus, such a password can be conveyed to the Creditor by the Person seeking credit, and the Creditor can use the password to prove to the Company that the Creditor is authorized to gain access to the information.

The password, or other proof of authorization, expires automatically after a predetermined event occurs. This event is, in the preferred embodiment, a predetermined amount of time after being issued to Person. Alternatively, the predetermined event is one or more uses of the password by anyone. A “use” of the password is an entry of the password into the Company's computer system, or some other measure of the disclosure of the password to the Company by someone seeking authorization. The term “expires” relates to the fact that the password serves as proof of authorization before it expires, and fails to serve as authorization after expires. Thus, an expired password is useless because it no longer operates as an authorization device to gain access to the information. The term “automatically” and “automatic” mean that the password expires without the need for additional human, machine or software steps to be executed, other than those steps that are set to be carried out at the time the password is conveyed by the Company to the Person. Thus, the password expires automatically, because it was “programmed”, when it was distributed, to expire after the predetermined event. Once the password has expired, it can be replaced by another password by the Company or the means that generates passwords. Alternatively, it is contemplated that no password immediately replaces the expired password.

The predetermined event is contemplated to be a predetermined amount of time or a predetermined number of uses. For example, the predetermined amount of time can be one minute, one hour, one day, one week or any other time period that is reasonable under the circumstances. The predetermined amount of time can be set by the Person, by the Company, or it can be random. Preferably, the predetermined amount of time is a sufficient amount of time for the Person to convey the password to the Creditor, the Creditor to convey the password to the Company, and the Company to permit access to the information needed by the Creditor. The predetermined number of uses can be one use, two uses, or any larger number of uses that is reasonable under the circumstances.

In the embodiment in which the password expires after a predetermined number of uses, there is preferably no time limitation on when the password expires. However, in still another alternative embodiment, the predetermined event is the first of a predetermined amount of time elapsing or a predetermined number of uses of the password. Any one or combination of conditions that triggers expiration of a password is acceptable as the predetermined event.

In one embodiment of the invention, the password generator is a conventional physical device, commonly referred to as a single-purpose computer, that operates according to a known algorithm and has a display for displaying the password. At predetermined intervals, the device calculates and displays a new password according to an algorithm, which is known to the entity that distributed the device. Such devices are commonly used by electronic stock trading companies, and restrict access to the password to those within the Company and anyone viewing the display.

In an alternative embodiment, the password generator is a computer program operating on a multipurpose computer according to an algorithm known to the Company. The program displays a new password at known intervals on the computer's monitor, and thereby functions much like the single purpose device. A still further alternative is a password generating website that the Person accesses using a permanent password, and the website displays to the Person the new, temporary password, which can be generated automatically, or can be chosen by the Person. Still further, kiosks, email and automatic and operator-monitored telephone systems can be used to generate and communicate passwords, and are therefore included within the term “password generator”. Of course, a combination of some or all of these alternatives is also possible.

Once the password is conveyed to the Creditor, the Creditor discloses the password to the Company as proof of authorization. This may occur as a result of the Company requesting proof of authorization, or by the Creditor offering the password to the Company during a transaction. In either case, or in any other feasible scenario, the Creditor conveys to the Company such password. Preferably, the Creditor does so before the expiration of the password.

After the Creditor receives the password, whether directly from the Person or from another source, it discloses the password to the Company. This disclosure can take place immediately, or after an intervening step in which the Company requests a password from the Creditor. If the Company receives an expired password, it refuses to disclose information about the Person to the Creditor. If the Company receives the password before the password has expired, the Company permits the Creditor to access the information about the Person. Thus, the Company treats an expired password as no password, and refuses disclosure of information about the Person.

An example of the invention is a database company, such as Equifax, that stores credit information about individuals. According to the invention, Equifax issues a password-generating device to individuals who have information in the database. In one example, the individuals pay a fee for this service, or it may come with other services, such as identity theft insurance, or for no charge. In order for anyone to access the information of a subscriber to this service, Equifax requires, for example, a social security number and a valid password. Without the required information, access is refused. Thus, the individual pays for the increased security of his or her sensitive credit information.

The password generator is preferably dynamic, meaning that it changes by the hour or some other short period of time. Thus, even if a potential identity thief obtains a current password, the password is only good for a brief period of time in this example. As noted above, the password generator can be of the single-purpose computer type used by Etrade, or it can be a conventional program running on a computer.

The two main benefits derived by the use of this method are to reduce identity theft and to maintain a higher credit score. Identity theft is reduced by preventing credit information from being obtained by an unauthorized person trying to establish credit using another person's social security number. If a creditor, such as a credit card company, is not able to obtain the credit records for the potential identity thief posing as another person, the creditor will be highly unlikely to extend credit to the potential identity thief. Furthermore, each time a credit file is obtained for an individual, that individual's credit score is reduced. The method will thus prevent unauthorized access to the records, thereby preventing a reduction in the credit score.

A preferred embodiment of the invention includes the use of a dynamic password generation device distributed to a user by a database company. The password on the device changes automatically after a period of time, such as every 24 hours. It is known that such conventional password generating devices change passwords automatically according to an algorithm. The issuing entity is aware of this algorithm, and thereby knows when, and to what password, the password-generating device changes the password. The use of this method provides an additional level of security since a stolen password is only valid for a limited amount of time.

In an alternative embodiment, as described briefly above, rather than the password generating device being physically sent to a user, a web site issues passwords to authorized users. Such users can then send the passwords to a creditor they wish to authorize to gain access to the information. By conveying a password, the user can rest in the fact that he or she is disclosing to the creditor a password that has a limited time during which access to information can occur. Of course, instead of a password generating website, the invention contemplates a kiosk computer, a telephone-operated password generating device, or any other such mechanism by which a user accesses his or her account, and is given a password that will expire.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method of restricting access to information, which information is retained by a company and relates to a person, to a third party authorized by the person, the method comprising:
(a) the person obtaining an authorization device, wherein the authorization device expires automatically after a predetermined event;
(b) the third party receiving the authorization device;
(c) the third party conveying the authorization device to the company;
(d) the company permitting the third party to access the information about the person before the authorization device has expired, and prohibiting the third party from accessing the information about the person after the authorization device has expired; and
(e) the authorization device expiring automatically after the predetermined event.

2. The method in accordance with claim 1, wherein the step of expiring automatically further comprises expiring after a predetermined amount of time has elapsed.

3. The method in accordance with claim 1, wherein the step of expiring automatically further comprises expiring after a predetermined number of uses of the authorization device.

4. The method in accordance with claim 2, further comprising the person conveying the authorization device to the third party.

5. The method in accordance with claim 4, wherein the step of obtaining further comprises using a password generating device to create a password.

6. The method in accordance with claim 4, wherein the step of obtaining further comprises the person creating a password.

7. The method in accordance with claim 1, wherein the step of obtaining further comprises using a computer program that generates passwords.

8. The method in accordance with claim 1, wherein the step of obtaining further comprises accessing a web site that generates passwords.

9. The method in accordance with claim 1, wherein the step of obtaining further comprises accessing a kiosk that generates passwords.

10. The method in accordance with claim 1, wherein the step of obtaining further comprises accessing a telephone system that generates passwords.

11. A method of restricting access to information, which information is retained by a company and relates to a person, to a third party authorized by the person, the method comprising:
(a) the person obtaining a password from a password generator, wherein the password expires after a predetermined time;
(b) the person conveying the password to the third party;
(c) the third party conveying the password to the company;
(d) the company permitting the third party to access the information about the person before the password has expired, and prohibiting the third party from accessing the information about the person after the password has expired; and
(e) the password expiring automatically after the passage of the predetermined time.
